(19) United States
(12) Patent Application Publication
(10) Pub. No.: US 2022/0092660 A1
(43) Pub. Date: Mar. 24, 2022

(54) APPARATUS AND METHOD FOR SYNAMIC ASSIGNMENT OF IDENTIFICATION DATA FOR A CONFIGURATION OF A PRODUCT CONFIGURATION SYSTEM

(71) Applicant: PHOENIX CONTACT GMBH & CO. KG, Blomberg (DE)

(72) Inventors: Peter KELLER, Oerlinghausen (DE); Matthias TIEBEN, Bad Salzuflen (DE); Jorg SCHMIDT, Petershagen (DE)

(21) Appl. No.: 17/292,402

(22) PCT Filed: Nov. 8, 2019
(86) PCT No.: PCT/EP2019/080716

§ 371 Date: May 7, 2021

(30) Foreign Application Priority Data
Nov. 9, 2018 (EP) 18205445.2

(51) Int. Cl. G06Q 30/06; G06Q 10/06

(52) U.S. Cl. CPC G06Q 30/0621; G06Q 10/06315; G06Q 30/0641; G06Q 30/0635

(57) ABSTRACT

The subject matter of the present invention relates to a method for dynamically assigning identification data for a configuration of a product configuration system, the method comprising the following method steps: acquiring (S1) a configuration data set for the configuration, the configuration data set having configuration property data; and providing (S2) a variant data set for variant configurations, the variant data set having item property data and identifier data of each item of a plurality of items; and comparing (S3) the configuration data set with the variant data set, wherein in case of a match of configuration property data of the configuration with article property data of a particular article of the variant data set, the identification data of the particular article of the variant data set is dynamically assigned to the configuration of the configuration data set; and generating (S4) an article reference number in case of no match of configuration properties of the configuration with the article property data of the variant configurations and dynamically assigning the generated article reference number to the identification data of the configuration.

### TECHNICAL FIELD

The present invention relates to systems for data transformation by standardized transformation processes and corresponding data migration methods for computer aided manufacturing.

In particular, the present invention relates to an apparatus and method for dynamically assigning identification data for a configuration of a product configuration system.

### TECHNICAL BACKGROUND

Today, for new variants of a product, for example generated by a product configurator, the customer can usually only request an offer for a customer-specific product in the so-called “customer self-service”. Direct order initiation from the configurator is not possible. This unnecessarily lengthens the data processing process in the producer's computer system and makes it more complicated in that there is no master data for this configuration in the internal system or computer system.

In a company, data on products in the areas of product procurement, production and distribution are often stored separately in the respective computer systems. An end-to-end implementation of a far-reaching and continuously networked and aligned data availability and data transformation is difficult to achieve.

### SUMMARY OF THE INVENTION

It is an object of the present invention to provide an improved apparatus and method for dynamically assigning identifier data for a configuration of a product configuration system.

This object of the present invention is solved by the objects of the independent patent claims. Further exemplary embodiments and further implementations of the present invention can be found in the dependent claims, the description and the figures of the drawings.

A first aspect of the present invention relates to a method for dynamically assigning identification data for a configuration of a product configuration system, the method comprising the following method steps.

As a first method step, a configuration data set for the configuration is acquired, the configuration data set comprising configuration characteristic data.

As a second method step a provision of a variant data set for variant configurations, the variant data set comprising article property data and identification data of each of a plurality of articles.

As a third method step, the configuration data set is compared with the variant data set, wherein in case of a match of configuration property data of the configuration with article property data of a particular article of the variant data set, the identification data of the particular article of the variant data set is dynamically assigned to the configuration of the configuration data set.

As a fourth method step, an article reference number is generated in case of no match of configuration properties of the configuration with the article property data of the variant configurations and dynamically assigning the generated article reference number, for example from the internal PLM system responsible for managing material numbers, to the identification data of the configuration.

The present invention further advantageously enables data from a product configurator to be transformed via transformation model into standardized internal material and value flows, and results from there to be transferred back into the configuration context.

The present invention further advantageously enables identifier data to be dynamically assigned for a configuration of a product configuration system, for which no system master data for the customer-specific configuration exists at the time of configuration composition by the customer.

The present invention further advantageously enables the user to directly evaluate each possible configuration according to the product model and to obtain a material number in an automated manner. Thus, directly from the context of the configuration, he is able to initiate the ordering process for his individual product immediately.

The present invention further advantageously achieves the goal of immediately and directly generating the material number via an electronic service and visualizing it in the configuration process.

The complete expression of all material master data for the configuration can be done at a later time.

The transformation model automatically transfers—at least partially or completely—extensive data packages into almost all systems relevant for order processing and manufacturing of a product and thus represents a core technology for intelligent production.

The method of the present invention further advantageously does not use its own program logic, but works, for example, on the basis of semantic relationships that are present in the standard functions of the systems involved, such as a web configurator, a web store, a simulation system, enterprise resource planning system, a production control system, or an automatic assembly aid. This results in a number of improvements for customer-specific product configurations, particularly in the context of the Fourth Industrial Revolution or just Industry 4.0.

Advantageously, the present invention enables the standardization of processes even in heterogeneous IT infrastructures and the guarantee of digital continuity in heterogeneous IT infrastructures.

Advantageously, the present invention enables any configured solution to also be ordered digitally and directly by the customer, even if these configured solutions have not yet been produced in the manufacturing systems and do not yet exist as such.

By automating the material system during the ordering process, internal efforts are significantly reduced and lead times for production orders are significantly minimized.

Standardization and automation improve data quality within the company. The transformation model comprises a method for transforming data from the digital customer interface, also referred to as a web configurator, into standardized internal material and value flows in order to control the automated control of machines, equipment, production processes.

Advantageous embodiments of the present invention can be found in the dependent claims.

In an advantageous embodiment of the present invention, it is provided that wherein the generated article reference number is dynamically stored in the variant data record as a new variant configuration.

In an advantageous embodiment of the present invention, it is provided that the generated article reference number is generated by linking the configuration properties of the configuration to the article property data of the variant configurations and/or is assigned sequentially.

In an advantageous embodiment of the present invention, it is provided that the configuration record comprises configuration master data and/or wherein the identification data comprises an article reference number.

In an advantageous embodiment of the present invention, it is provided that the variant data set comprises variant master data from an article.

In an advantageous embodiment of the present invention, it is provided that in case the configuration property data of the configuration matches the article property data of the variant data set, the variant master data of the variant data set is dynamically assigned to the configuration data set as configuration master data.

In a second aspect of the present invention, there is provided an apparatus for dynamically assigning identification data for a configuration of a product configuration system, the apparatus comprising an acquisition module, a variant database, and a data processing module.

The acquisition module is configured to acquire a configuration record for the configuration, the configuration record having configuration property data.

The variant database is configured to provide a variant configuration data set, the variant data set having item property data and identification data of each of a plurality of items.

The data processing module is adapted to compare the configuration data set with the variant data set of variant configurations, wherein the data processing module is further adapted to, in case of a match of configuration property data of the configuration with the article property data of a particular article of the variant data set, dynamically assign the identification data of the particular article of the variant data set to the configuration of the configuration data set, and in the case of no match of the configuration property data of the configuration with the article property data of the variant data set, generate an article reference number and dynamically assign the generated article reference number to the configuration.

In an advantageous exemplary embodiment of the present invention, it is provided that the variant database is adapted to dynamically store the generated article reference number in the variant data record as a new variant configuration.

In an advantageous exemplary embodiment of the present invention, it is provided that the data processing module is configured to generate the generated article reference number by linking the configuration properties of the configuration to the article property data of the variant configurations and/or to sequentially assign the generated article reference number.

In an advantageous exemplary embodiment of the present invention, it is provided that the configuration record comprises configuration master data and/or wherein the identification data comprises an article reference number.

In an advantageous exemplary embodiment of the present invention, it is provided that the variant data set comprises variant master data from an article.

In a third aspect of the present invention, there is provided a computer network system comprising the apparatus according to the second aspect of the present invention or any embodiment of the second aspect.

In a fourth aspect of the present invention, there is provided a computer program or computer program product comprising instructions which, when the program is executed by a computer, cause the computer to perform the steps of the method for dynamically assigning identification data for a configuration of a product configuration system in accordance with the first aspect of the present invention.

In a fifth aspect of the present invention, there is provided a computer readable data storage medium comprising instructions which, when executed by a computer, cause the computer to perform the steps of the method for dynamically assigning identification data for a configuration of a product configuration system in accordance with the first aspect of the present invention.

The present invention further advantageously enables automated material and item creation for a product configurator.

The automated generation of structured digital data enables to fully automate the process chain from digital customer interface to manufacturing based on autonomous data generation and data management.

In a sixth aspect of the present invention, there is provided a client-server method for dynamically assigning identification data for a customer-specific configuration of a product configuration system of a computer network system in which a plurality of decentralized data processing devices are connected via a data network in a data transmission link.

Furthermore, in the client-server method, it is provided that at least one variant database is stored in a decentralized data processing device, which database provides a variant data record for variant configurations; wherein the variant data record contains article property data and identification data of an article.

Further, in the client-server method, it is provided that a variant data set is defined for each article of the plurality of articles.

Furthermore, the client-server method provides that configuration properties of the customer-specific configuration are recorded in the form of a configuration data record, the configuration data record containing configuration property data.

Furthermore, the client-server method provides that the configuration data record of the customer-specific configuration is compared with the variant data record of the variant configurations.

Furthermore, the client-server method provides that, in the event of a match between configuration property data of the customer-specific configuration and the article property data of the variant data set, the identification data of the variant data set is assigned to the customer-specific configuration of the configuration data set.

Furthermore, in the case of the client-server method, it is provided that if the configuration property data of the configuration does not match the article property data of the variant data record, an article reference number is generated and the generated article reference number is dynamically assigned to the configuration.

The described embodiments and further embodiments can be combined with each other as desired.

Other possible embodiments, further embodiments and implementations of the present invention also include combinations, not explicitly mentioned, of features of the present invention described previously or hereinafter with respect to the embodiments.

The accompanying drawings are intended to provide a further understanding of embodiments of the present invention.

The accompanying drawings illustrate embodiments and, in connection with the description, serve to explain concepts of the present invention.

Other embodiments and many of the advantages mentioned will result with regard to the figures of the drawings. The elements shown in the figures of the drawings are not necessarily shown to scale with respect to each other.

### BRIEF DESCRIPTION OF THE FIGURES

FIG. 1: a schematic representation of a device for dynamically assigning identification data for a configuration of a product configuration system according to an exemplary embodiment of the present invention;

FIG. 2: a schematic diagram of a flowchart of a method for dynamically assigning identification data for a configuration of a product configuration system according to an exemplary embodiment of the present invention;

FIG. 3: a schematic diagram of a device for converting data from a digital customer interface of a computer network system in accordance with an embodiment of the present invention;

FIG. 4 a comparison of the configuration result with known articles according to an exemplary embodiment of the present invention;

FIG. 5 an extension of the catalog of the variant database according to an exemplary embodiment of the present invention;

FIG. 6 a query and a filing of newly generated material numbers according to an exemplary embodiment of the present invention; and

FIG. 7 an adapted update process for the known item master of the variant database according to an exemplary embodiment example of the present invention.

### DETAILED DESCRIPTION OF THE EMBODIMENTS

In the figures of the drawings, identical reference signs denote identical or functionally identical elements, parts, components or process steps, unless otherwise indicated.

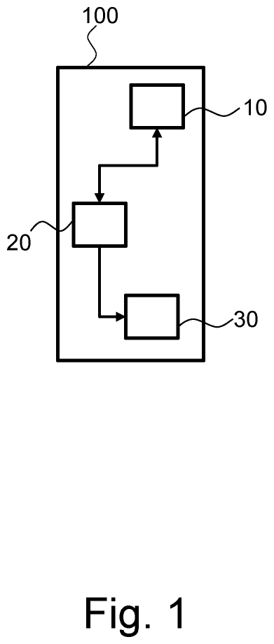

FIG. 1 shows a schematic representation of a device for dynamically assigning identification data for a configuration of a product configuration system according to an exemplary embodiment of the present invention.

The apparatus 100 includes an acquisition module 10, a variant database 20, and a data processing module 30.

The acquisition module 10 is configured to acquire configuration properties of the configuration in the form of a configuration data set, wherein the configuration data set includes configuration property data.

The variant database 20 is configured to provide a variant data set for variant configurations, the variant data set defining item property data and identification data of an item of the plurality of items of the variant configurations.

The data processing module 30 is adapted to compare the configuration data set with the variant data set of the variant configurations, wherein the data processing module is further adapted to, in case of a match of configuration property data of the configuration with the article property data of the variant data set, dynamically assign the identification data of the variant data set to the configuration of the configuration data set, and in case of no match of the configuration property data of the configuration with the item property data of the variant data set, generate an item reference number and dynamically assign the generated item reference number to the configuration.

The apparatus 100 enables the supply chain of information for processing orders to be optimized in such a way that orders are processed as automatically as possible.

To this end, the device 100 can provide optimized configurators and services that provide need-based and up-to-date information on products as part of the communication with the customer.

The vertical integration of the device 100 is advantageous because this implements the networking between customer requirements and the definition of order content with production, thus providing optimized support for the horizontal value chain.

The device 100 is designed to provide the option of generating material numbers for this purpose and to derive their characteristics on the basis of the configuration results from a knowledge base as stored in the variant database 20.

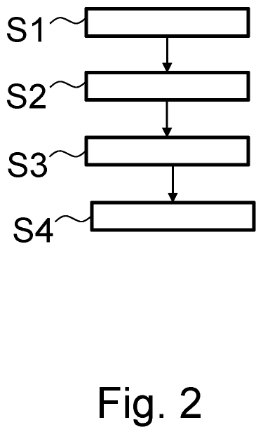

FIG. 2 a schematic diagram of a flowchart of a method for dynamically assigning identification data for a configuration of a product configuration system according to an exemplary embodiment example of the present invention.

As a first method step, an acquisition S1 of a configuration data set for the configuration is performed, wherein the configuration data set comprises configuration characteristic data.

As a second method step there is provided S2 of a variant data set for variant configurations, the variant data set comprising article property data and identification data of each of a plurality of articles.

As a third method step, comparing S3 the configuration data set with the variant data set, wherein in case of a match of configuration property data of the configuration with article property data of a particular article of the variant data set, the identification data of the particular article of the variant data set is dynamically assigned to the configuration of the configuration data set; and as a fourth method step, generating S4 an article reference number in case of no match of configuration properties of the configuration with the article property data of the variant configurations and dynamically assigning the generated article reference number to the identification data of the configuration.

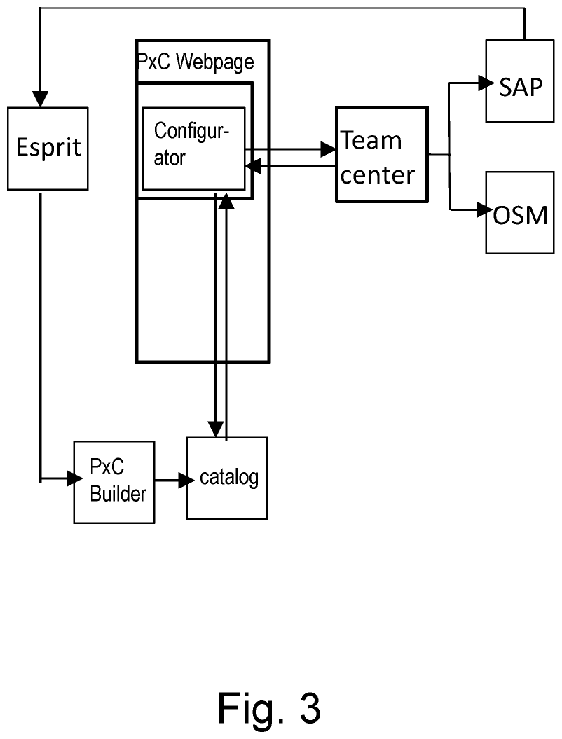

FIG. 3 shows a schematic diagram of a device for converting data from a digital customer interface of a computer network system according to an exemplary embodiment of the present invention.

The following systems are integrated into the process and can be coupled to the device 100.

A modular configurator for customer-specific product configuration may be integrated into the acquisition module 10 of the device 100 or coupled to the acquisition module 10, and may enable customer-specific product configuration and quotation generation via a product configurator.

An application server as a platform for integration processes may be coupled to the device 100 or integrated into the data processing module 30.

The device 100 may further be coupled to a product lifecycle management, PLM, software or a PLM application may be integrated into the data processing module 30.

The device 100 may further be coupled to software for managing business processes of an enterprise such as accounting, controlling, sales, purchasing, production, warehousing, and human resources, or such software architecture may be integrated into the data processing module 30.

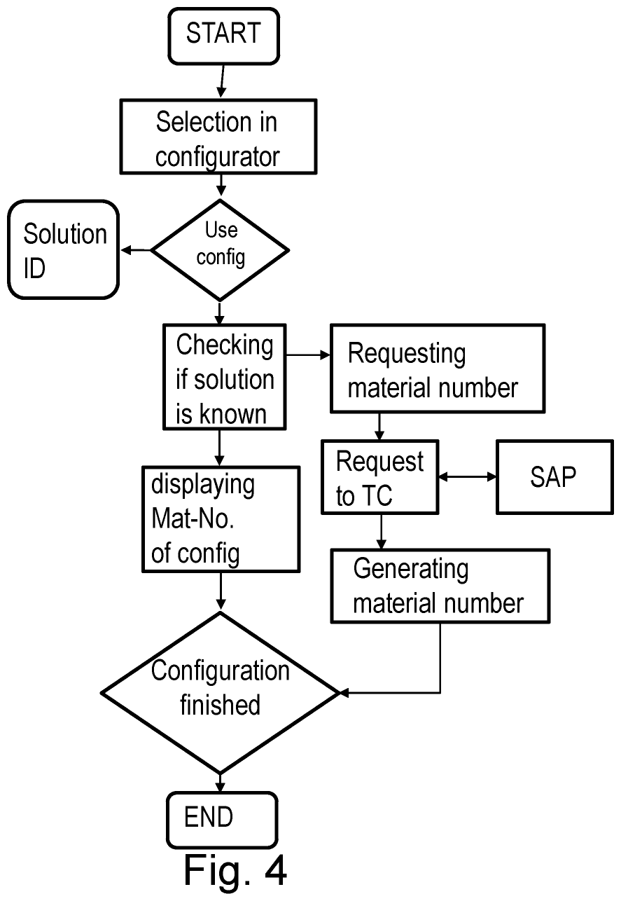

FIG. 4 shows a comparison of the configuration result with known articles according to an exemplary embodiment of the present invention.

The configuration result is compared by the data processing module 30 with the contents of the catalog. For this purpose, the list of features evaluated in the configurator is transferred and compared with all known articles.

If an entry with exactly the requested value combination already exists, the material number is read from the database of the variant database 20 and returned to the configurator (“configuration already stored in reference database”).

If, on the other hand, this combination of values is not known, no material number is returned accordingly.

The existing data structure in the catalog of the variant database 20 is extended by a column that indicates the status of the known articles.

If it is an article that can be sold, the value “Verified” is displayed here, otherwise it is the status “Inquiry”. This status makes it possible to react differently to the user in the configurator.

An article that is not yet ready for sale cannot be added directly to the shopping cart, but can only be requested. Depending on the status of the item found, the customer can be shown either the option “add to shopping cart” or “request item”.

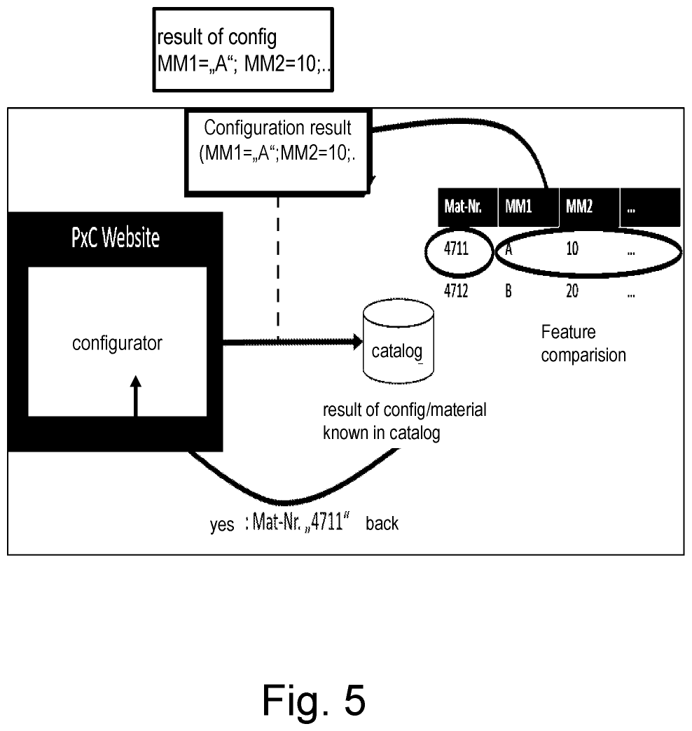

FIG. 5 shows an extension of the catalog of the variant database 20 according to an exemplary embodiment of the present invention.

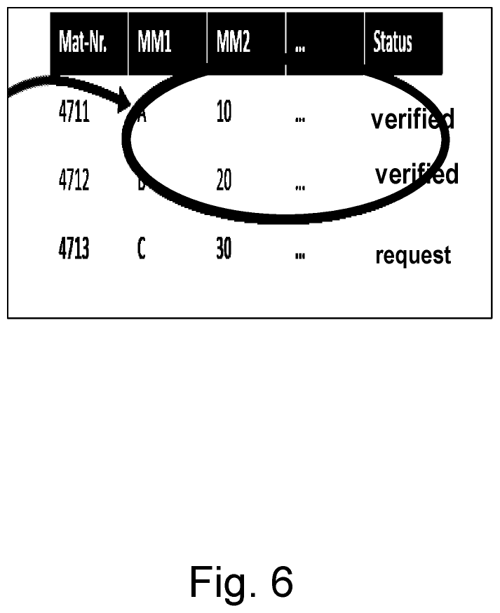

FIG. 6 shows a request and a filing of newly generated material numbers according to an exemplary embodiment or example of the present invention.

When a configuration is requested, a new material number is assigned and returned to the configurator. This is stored directly by the configurator in the catalog for comparison with later configuration results.

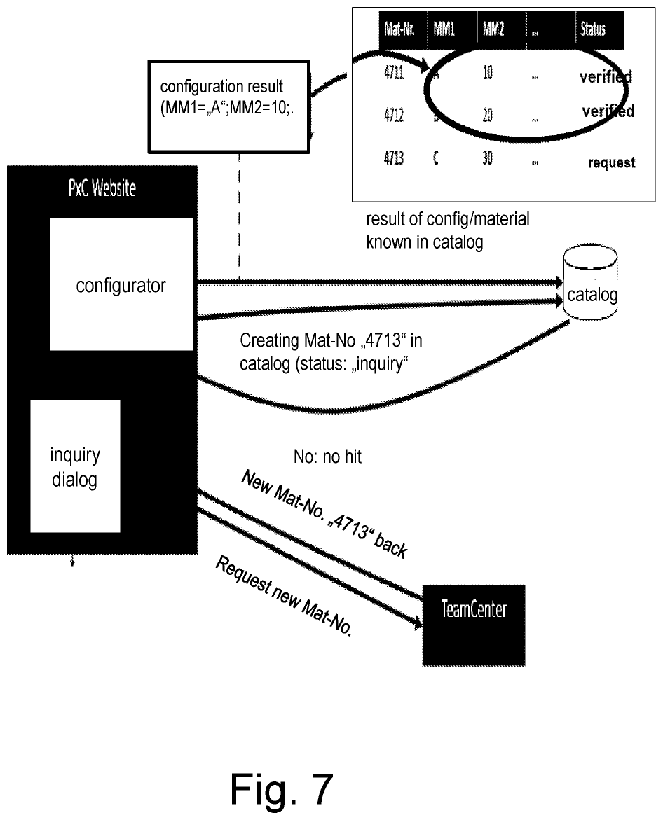

FIG. 7 shows an adapted update process for the known article master of the variant database 20 according to an exemplary embodiment of the present invention.

The contents of the catalog of the variant database 20 are updated with current product master data. In methods not according to the present invention, this functions via a manual triggering of a software module implemented specifically for this purpose.

In this process, an XML file with the complete contents of the master data is derived. The software module creates a file in a predefined XML format from this, also with the help of other sources. This is subsequently imported into the database of variants catalog by exchanging the complete content.

The present invention makes here a fully automated data exchange possible, an autonomously taking place import into a delta adjustment are changed, so that in the catalog only the new or changed articles must be imported.

New articles get a new automatically generated entry, with the status “Verified”, changed articles are overwritten with the current content.

Should an article have had the status “Inquiry” and is updated this way, it changes the status to “Verified”.

Thus, the present invention further advantageously allows a delta update of the variant database to be performed instead of a complete update.

To determine the delta update, the last complete export is compared with the current export. This means that two states are always saved.

In this way, the file to be imported by the catalog will become significantly smaller in the future, so that in addition fewer restrictions on runtime operation are also to be expected.

According to an exemplary embodiment of the present invention, a method is provided for providing a client-server method for dynamically assigning identification data for a customer-specific configuration of a product configuration system of a computer network system, in which a plurality of decentralized data processing devices are connected via a data network in a data transmission connection.

According to one exemplary embodiment of the present invention, it is provided that at least one variant database is stored in a decentralized data processing device, which database provides a variant data set for variant configurations; wherein the variant data set contains article property data and identification data of an article.

According to one exemplary embodiment of the present invention, a variant data set is defined for each article of the plurality of articles.

According to an exemplary embodiment of the present invention, it is provided that configuration properties of the customized configuration are captured in the form of a configuration data set, the configuration data set including configuration property data.

According to an exemplary embodiment of the present invention, it is provided that the configuration data set of the customer-specific configuration is compared with the variant data set of variant configurations.

According to one embodiment of the present invention, it is provided that in the event of a match of configuration property data of the customer-specific configuration with the article property data of the variant data record, the identification data of the variant data record is assigned to the customer-specific configuration of the configuration data record

According to one embodiment of the present invention, if the configuration property data of the configuration does not match the article property data of the variant data set, an article reference number is generated and the generated article reference number is dynamically assigned to the configuration.

Although the present invention has been described above with reference to preferred embodiments, it is not limited thereto, but can be modified in a variety of ways. In particular, the invention can be changed or modified in a variety of ways without departing from the essence of the invention.

Additionally, it should be noted that “comprising” and “comprising” do not exclude other elements or steps, and “one” or “a” do not exclude a plurality.

1. A method for dynamically assigning identification data for a configuration of a product configuration system, the method comprising the steps of:
acquiring from a configuration data set for the configuration, the configuration data set having configuration characteristic data;
providing a variant data set for variant configurations, the variant data set having item property data and identification data of each of a plurality of items; and
comparing the configuration data set with the variant data set, wherein in case of a match of configuration property data of the configuration with article property data of a particular article of the variant data set, the identification data of the particular article of the variant data set is dynamically assigned to the configuration of the configuration data set; and
generating an article reference number in case of no match of configuration properties of the configuration with the article property data of the variant configurations, and dynamically assigning the generated article reference number to the identification data of the configuration.

2. The method according to claim 1, wherein the generated article reference number is dynamically stored in the variant data record as a new variant configuration.

3. The method according to claim 1, wherein the generated article reference number is generated by linking the configuration properties of the configuration with the article property data of the variant configurations and/or is assigned sequentially.

4. The method according to claim 1, wherein the configuration record comprises configuration master data and/or wherein the identification data comprises an article reference number.

5. The method according to claim 1, wherein the variant data set comprises variant master data from an article.

6. The method according to claim 1, wherein, in the case of a match between the configuration property data of the configuration and the article property data of the variant data set, the variant master data of the variant data set is dynamically assigned to the configuration data set as configuration master data.

7. An apparatus for dynamically assigning identification data for a configuration of a product configuration system, the apparatus comprising:
an acquisition module configured to acquire a configuration data set for the configuration, the configuration data set having configuration property data;
a variant database adapted to provide a variant data set for variant configurations, the variant data set having item property data and identification data of each of a plurality of items; and
a data processing module adapted to compare the configuration data set with the variant data set of variant configurations, wherein the data processing module is further adapted to, in case of a match of configuration property data of the configuration with the article property data of a particular article of the variant data set, dynamically assigning the identification data of the particular article of the variant data set to the configuration of the configuration data set, and in the case of no match of the configuration property data of the configuration with the article property data of the variant data set, generating an article reference number and dynamically assigning the generated article reference number to the configuration.

8. The apparatus according to claim 7, wherein the variant database is configured to dynamically store the generated article reference number in the variant data record as a new variant configuration.

9. The apparatus according to claim 7, wherein the data processing module is configured to generate the generated article reference number by linking the configuration properties of the configuration to the article property data of the variant configurations or to assign the generated article reference number sequentially.

10. The apparatus according to claim 7, wherein the configuration record comprises configuration master data and/or wherein the identification data comprises an article reference number.

11. The apparatus according to claim 7, wherein the variant data set comprises variant master data from an article.

12. The apparatus of claim 7 wherein the apparatus is part of a computer system.

12. The apparatus of claim 7 wherein the apparatus is part of a computer network.

13. The apparatus of claim 12 wherein the computer network comprises a web configurator, a web store, a simulation system, an enterprise resource planning system, a production control system, or an automatic assembly aid.

14. The apparatus of claim 12 wherein the computer network is designed as a heterogeneous information technology (IT) system.

15. A client-server system for dynamically assigning identification data for a customer-specific configuration of a product configuration system of a computer network system, wherein the client-server system comprises:
a plurality of decentralized data processing devices connected via a data network in a data transmission link;
wherein at least one variant database is stored in a decentralized data processing device, which database provides a variant data record for variant configurations;
wherein the variant data set contains article property data and identification data of an article, wherein a variant data set is defined for each article of the plurality of articles; and wherein configuration properties of the customized configuration are captured in the form of a configuration record, the configuration record containing configuration property data;
wherein the configuration data set of the customer-specific configuration is compared with the variant data set of the variant configurations;
wherein in case of a match of configuration property data of the customer individual configuration with the article property data of the variant data record, the identification data of the variant data record is assigned to the customer individual configuration of the configuration data record; and
wherein in case of no match of the configuration property data of the configuration with the article property data of the variant data record, an article reference number is generated and the generated article reference number is dynamically assigned to the configuration.
